(19) United States
(12) Patent Application Publication
(10) Pub. No.: US 2021/0148812 A1
(43) Pub. Date: May 20, 2021

(54) MOISTURE DETECTION SYSTEM AND METHOD

(71) Applicant: Steering Solutions IP Holding Corporation, Saginaw, MI (US)

(72) Inventors: Haiquan Li, Rochester Hills, MI (US); Shunqing Yang, Grand Blanc, MI (US)

(21) Appl. No.: 17/035,022

(22) Filed: Sep. 28, 2020

Related U.S. Application Data
(60) Provisional application No. 62/936,927, filed on Nov. 18, 2019.

(51) Int. Cl. G01N 21/31; G01N 21/25

(52) U.S. Cl. CPC G01N 21/31; G01N 21/255; G01N 2201/062; G01N 2201/0216; G01N 2201/0238

(57) ABSTRACT

A moisture detection system includes a component including a material switchable between a first color and a second color, the component being the first color in a dry condition and the second color in a wet condition. The system also includes at least one light emitting component positioned to emit a color of light onto the component. The system further includes at least one light detection component positioned to receive a color of light after reflection of the color of light emitted by the at least one light emitting component, the color received by the light detection component indicating whether the component is in the dry condition or the wet condition.

### CROSS-REFERENCE TO RELATED APPLICATION

This application claims the benefit of priority to U.S. Provisional Patent Application Ser. No. 62/936,927, filed Nov. 18, 2019, the disclosure of which is incorporated by reference herein in its entirety.

### BACKGROUND

Many applications across numerous industries employ electronic control units (ECUs) to perform a variety of tasks. Certain conditions allow for moisture to undesirably enter an ECU. The moisture can damage hardware, make the system unable to perform as intended, or render it completely inoperable. Therefore, moisture detection at an initial time is beneficial. However, typical detection methods require light wavelength measurement and are expensive.

### SUMMARY OF THE DISCLOSURE

According to one aspect of the disclosure, a moisture detection system is provided. The system includes a component including a material switchable between a first color and a second color, the component being the first color in a dry condition and the second color in a wet condition. The system also includes at least one light emitting component positioned to emit a color of light onto the component. The system further includes at least one light detection component positioned to receive a color of light after reflection of the color of light emitted by the at least one light emitting component, the color received by the light detection component indicating whether the component is in the dry condition or the wet condition.

According to another aspect of the disclosure, a moisture detection system includes a component including a material switchable between a first color and a second color, the component being the first color in a dry condition and the second color in a wet condition. The system also includes a first light emitting component positioned to emit a first color of light onto the component. The system further includes a second light emitting component positioned to emit a second color of light onto the component. The system yet further includes a first light detection component positioned to detect reflection of the first color of light if reflection off of the component of the first color of light is present. The system also includes a second light detection component positioned to detect reflection of the second color of light if reflection off of the component of the second color of light is present, wherein detection of the first color of light or the second color of light indicates whether the component is in the dry condition or the wet condition.

According to another aspect of the disclosure, a method of detecting moisture is provided. The method includes emitting a first color of light from a first light emitting component onto a component at least partially formed of a material switchable between a first color and a second color. The method also includes emitting a second color of light from a second light emitting component onto the component. The method further includes attempting to detect the first color of light with a first light detection component positioned to detect reflection of the first color of light if reflection off of the component of the first color of light is present. The method yet further includes attempting to detect the second color of light with a second light detection component positioned to detect reflection of the second color of light if reflection off of the component of the second color of light is present. The method also includes determining that the component is in the wet condition if the first light detection component detects reflection of the first color. The method further includes determining that the component is in the dry condition if the second light detection component detects reflection of the second color.

These and other advantages and features will become more apparent from the following description taken in conjunction with the drawings.

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a moisture detection system in a first condition according to one aspect of the disclosure;

FIG. 2 illustrates the moisture detection system of FIG. 1 in a second condition;

FIG. 3 illustrates various colors of light being received and emitted with various colors of the moisture detection system according to another aspect of the disclosure;

FIG. 4 is a moisture detection system in a first condition according to another aspect of the disclosure;

FIG. 5 illustrates the moisture detection system of FIG. 4 in a second condition; and

FIG. 6 illustrates the moisture detection system of FIG. 4 in a third condition.

### DETAILED DESCRIPTION

Referring now to the Figures, where the invention will be described with reference to specific embodiments, without limiting same, various embodiments of the invention disclosed herein are shown.

The embodiments disclosed herein provide a system and method of detecting moisture that is within an electronic control unit (ECU). This relates to detection of moisture that is in close proximity to, or in contact with, an ECU. Numerous industrial applications may benefit from the embodiments disclosed herein. By way of non-limiting example, a vehicle steering system may include the moisture detection system and method. Such an example may include detecting moisture that is inside an ECU housing or inside a steering gear boot.

Although the term “moisture” is used throughout the disclosure, it is to be understood that this term is defined as any level of moisture, including humidity, for example.

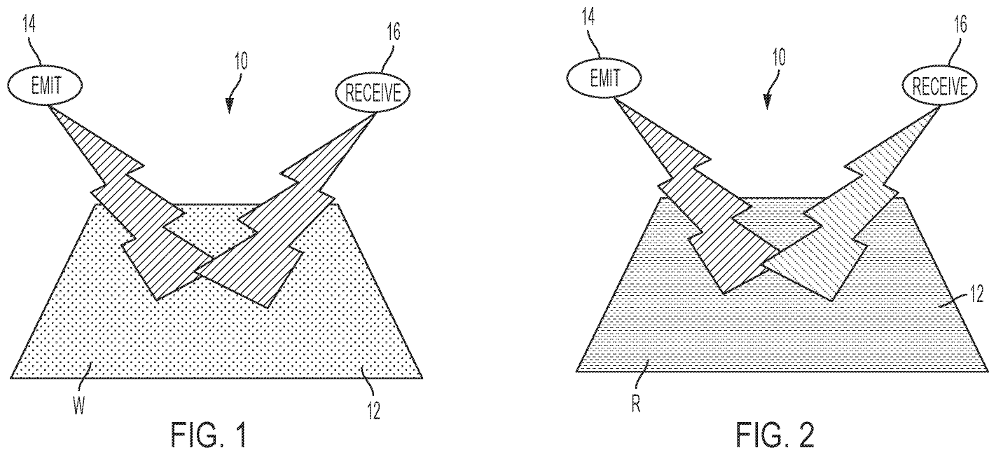

Referring now to FIGS. 1 and 2, a moisture detection system according to a first embodiment is shown and is generally referenced with numeral 10. The moisture detection system 10 includes a component that may be formed of any suitable material capable of changing colors upon contact with moisture. The component may be secured to an object with an adhesive or in any other contemplated manner. There are numerous materials that are capable of changing colors when placed in contact with moisture. For example, cobalt chloride (CoCl₂) is known to change from blue to pink when placed in contact with moisture. Another example is copper sulfate (CuSO₄), which changes from white to blue when placed in contact with moisture. The preceding examples are merely illustrative of materials that may be included in the component that is part of the moisture detection system 10.

In the embodiments illustrated in FIGS. 1 and 2, a material 12 that changes from white (FIG. 1) to red (FIG. 2) is employed as an example. In other words, when the material of the component is dry it is white, but upon contact with moisture the component changes to a red color. A light emitting component 14 is provided to emit a color of light on the component. In the illustrated example, the emitted light is green. The green light is reflected off the component 12 and received by a light detection component 16. The light detection component 16 determines the amount of color (e.g., green) that is received after reflection off the component 12. The received color is indicative of whether the component 12 is in a white condition (i.e., dry condition shown in FIG. 1) or a red condition (i.e., wet condition shown in FIG. 2). In particular, a threshold amount of green light received by the light detection component 16 is indicative because most of the green light emitted onto the component 12 is detected when the component material 12 is white and less than a threshold amount of green light is detected when the component material is red. The amount of green color detected is indicative of the component's color and this definitively indicates whether the component 12 is wet.

Although the embodiment described above in connection with FIGS. 1 and 2 is described with specific colors, it can be readily understood that different colors may be utilized with different materials and the preceding example is not intended to be limiting.

Referring now to FIGS. 3-6, another embodiment of the moisture detection system is illustrated. In the illustrated embodiment, the moisture detection system includes a component 22 that may be formed of any suitable material capable of changing colors upon contact with moisture. The component 22 may be secured to an object with an adhesive or in any other contemplated manner. There are numerous materials that are capable of changing colors when placed in contact with moisture. For example, as described above, cobalt chloride (CoCl₂) is known to change from blue to pink when placed in contact with moisture. Another example is copper sulfate (CuSO₄), which changes from white to blue when placed in contact with moisture. The preceding examples are merely illustrative of materials that may be included in the component 22 that is part of the moisture detection system.

The moisture detection system includes a plurality of light emitting components 24. In the illustrated embodiment, a first light emitting component 26, a second light emitting component 28, and a third light emitting component 30 are provided to each emit a distinct color of light on the component 22. It is to be appreciated that more or fewer light emitting components 24 are contemplated. In the illustrated embodiment, a blue light is emitted, a red light is emitted and a green light is emitted, with each color of light reflected off the component 22. As shown, numerous examples of colors of materials are contemplated. Each color of material reflects a different color, or combination of colors, which is received by a light detection component 32.

The light detection component 32 determines which color(s) is received after reflection off the component 22. The received color is indicative of whether the component 22 is in a dry condition or in a wet condition. Although the embodiment described above in connection with FIG. 3 is described and illustrated with specific colors, it can be readily understood that different colors may be utilized with different materials and the preceding example is not intended to be limiting.

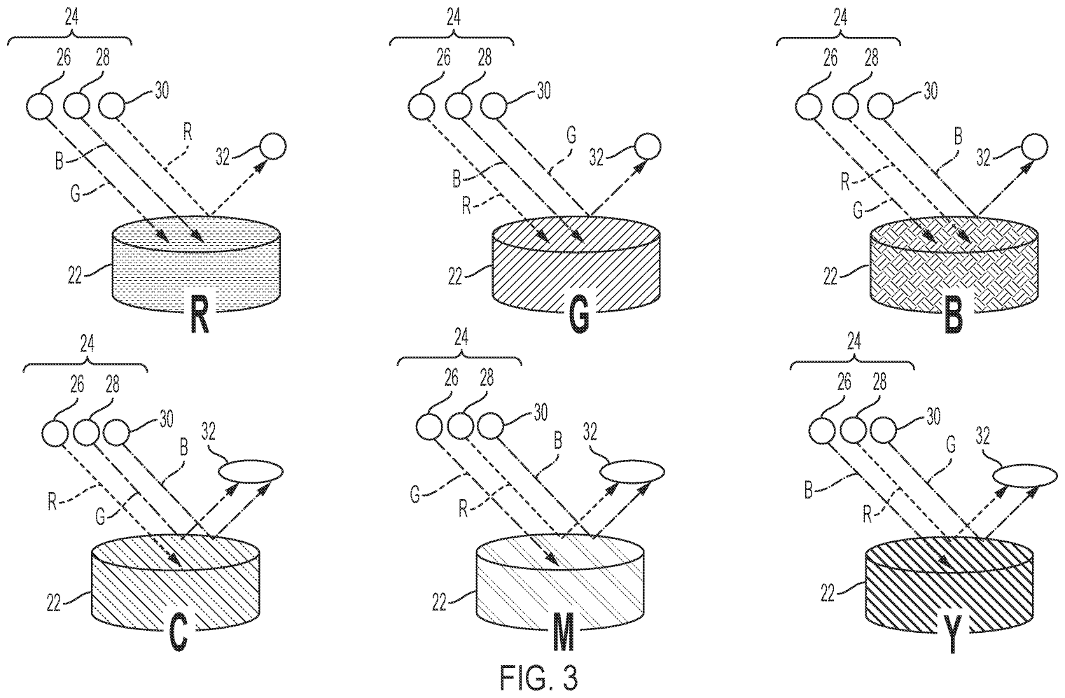

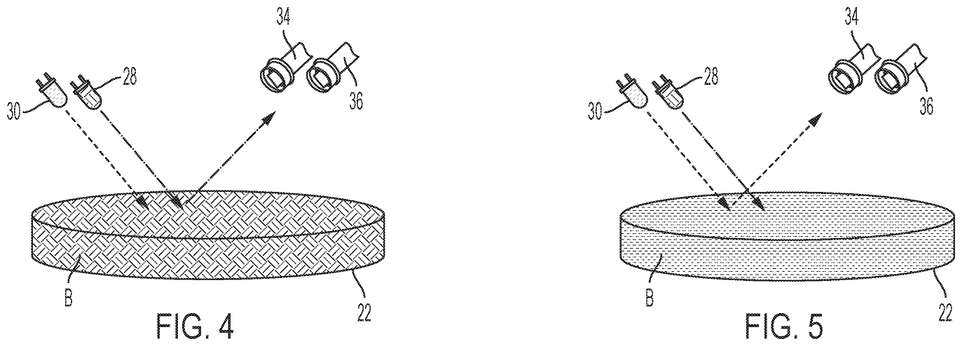

FIGS. 4-6 illustrate a specific arrangement of light combinations which may be employed to determine whether the component 22 is dry or wet. In the illustrated embodiment, only two light emitting components 24 (e.g., LEDs) are provided. One component emits blue 28 and the other emits red 30. Correspondingly, two light detection components 34, 36 are provided and positioned to receive the light off the component 22. For example, the light detection components 34, 36 may be optical diodes which are capable of detecting different light colors.

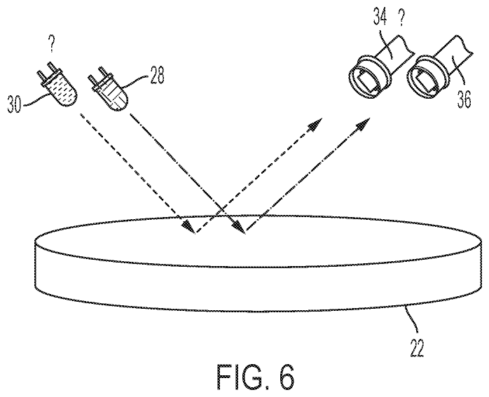

FIG. 4 shows the component 22 in a dry condition, indicated with a blue color of the component. In such a condition, only blue reflected light is detected by the optical diode capable of detecting blue light, while red is not detected. FIG. 5 shows the component 22 in a wet condition, indicated with a red color of the component 22. In such a condition, only red reflected light is detected by the optical diode capable of detecting red light, while blue is not detected. FIG. 6 shows both red and blue light being detected upon reflection off the component. This is indicative of an error state and further investigation is advisable.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A moisture detection system comprising:
a component including a material switchable between a first color and a second color, the component being the first color in a dry condition and the second color in a wet condition;
at least one light emitting component positioned to emit a color of light onto the component; and
at least one light detection component positioned to receive a color of light after reflection of the color of light emitted by the at least one light emitting component, the color received by the light detection component indicating whether the component is in the dry condition or the wet condition.

2. The moisture detection system of claim 1, wherein the system is provided in a vehicle steering system.

3. The moisture detection system of claim 2, wherein the system is at least partially located inside an ECU housing.

4. The moisture detection system of claim 2, wherein the system is at least partially located inside a steering gear boot.

5. The moisture detection system of claim 1, wherein the material of the component is cobalt chloride (CoCl₂).

6. The moisture detection system of claim 1, wherein the material of the component is copper sulfate (CuSO₄).

7. A moisture detection system comprising:
a component including a material switchable between a first color and a second color, the component being the first color in a dry condition and the second color in a wet condition;
a first light emitting component positioned to emit a first color of light onto the component;
a second light emitting component positioned to emit a second color of light onto the component;
a first light detection component positioned to detect reflection of the first color of light if reflection off of the component of the first color of light is present; and
a second light detection component positioned to detect reflection of the second color of light if reflection off of the component of the second color of light is present, wherein detection of the first color of light or the second color of light indicates whether the component is in the dry condition or the wet condition.

8. The moisture detection system of claim 7, wherein the first light detection component and the second light detection component are each optical diodes.

9. The moisture detection system of claim 7, wherein the system is provided in a vehicle steering system.

10. The moisture detection system of claim 9, wherein the system is at least partially located inside an ECU housing.

11. The moisture detection system of claim 9, wherein the system is at least partially located inside a steering gear boot.

12. The moisture detection system of claim 7, wherein the material of the component is cobalt chloride (CoCl₂).

13. The moisture detection system of claim 7, wherein the material of the component is copper sulfate (CuSO₄).

14. A method of detecting moisture comprising:
emitting a first color of light from a first light emitting component onto a component at least partially formed of a material switchable between a first color and a second color;
emitting a second color of light from a second light emitting component onto the component;
attempting to detect the first color of light with a first light detection component positioned to detect reflection of the first color of light if reflection off of the component of the first color of light is present;
attempting to detect the second color of light with a second light detection component positioned to detect reflection of the second color of light if reflection off of the component of the second color of light is present;
determining that the component is in the wet condition if the first light detection component detects reflection of the first color; and
determining that the component is in the dry condition if the second light detection component detects reflection of the second color.

15. The method of claim 14, further comprising determining that the component is in an unknown condition if the first color of light is detected by the first light detection component and the second color of light is detected by the second light detection component.

16. The method of claim 14, wherein the first light detection component and the second light detection component are each optical diodes.

17. The method of claim 14, wherein the first light emitting component and the second light emitting component are each LEDs.
